(19) United States
(12) Patent Application Publication
(10) Pub. No.: US 2021/0376676 A1
(43) Pub. Date: Dec. 2, 2021

(54) SWITCHED RELUCTANCE MOTOR

(71) Applicants: Hyundai Motor Company, Seoul (KR); Kia Motors Corporation, Seoul (KR)

(72) Inventor: Hashimoto Takenori, Yokohama-Shi (JP)

(21) Appl. No.: 17/134,975

(22) Filed: Dec. 28, 2020

(30) Foreign Application Priority Data
May 28, 2020 (JP) 2020-92893

(51) Int. Cl. H02K 1/30; H02K 1/24; H02K 19/10

(52) U.S. Cl. CPC H02K 1/30; H02K 19/103; H02K 1/246

(57) ABSTRACT

A switched reluctance motor is provided that prevents deformation or damage of a bridge member assembled on a rotor at high speed rotation of the rotor. The motor includes a stator having a plurality of magnetic pole protrusions with a coil wound thereon and a rotor having a plurality of magnetic pole protrusions. A bridge member is formed in a T-shaped sectional shape consisting of a roof portion, a leg portion, and a foot portion and buries a gap between the magnetic pole protrusions of the rotor in a state of being supported to the rotor at three places including the foot portion (4c) and opposite end portions of the roof portion. Additionally, end plates are configured to close opposite end portions of the rotor.

### CROSS REFERENCE TO RELATED APPLICATION

The present application claims priority to Japanese Patent Application No. 2020-92893, filed May 28, 2020, the entire contents of which is incorporated herein for all purposes by this reference.

### BACKGROUND

### Field of the Disclosure

The present disclosure relates generally to a switched reluctance motor (SRM) and, more particularly, to a switched reluctance motor provided with a bridge member having no deformation caused by centrifugal force even when the motor is rotated at a high speed.

### Description of the Related Art

In FIGS. 12A and 12B, a view illustrating an internal structure of a switched reluctance motor (SRM), which is a synchronous motor, is shown along with that of a permanent magnet synchronous motor (PMSM), which is also a synchronous motor according to the prior art. In the PMSM, a permanent magnet is embedded in a rotor, and the rotor rotates in synchronization with a rotating magnetic field generated from a stator. On the other hand, in the SRM, a rotor is not provided with a permanent magnet embedded therein and is formed, for example, to have a protrusion made of a silicon steel plate obtained by adding a small amount of silicon to iron. The SRM has a simpler rotor structure than the PMSM, is suitable for high speed rotation, and does not require a rare metal for a permanent magnet, and is thereby being reviewed again for practical application.

As shown in FIG. 13 or the prior art, in a variable magnet resistive motor, which is an SRM, a bridging 26 is provided in a groove between magnetic pole projections of a rotor 20 and a stator 10, and material is filled in the groove to reduce windage loss due to the rotation of the rotor 20 within the stator. However, when the rotor of the SRM is rotated at a high speed of 20,000 to 30,000 (number of revolutions/min), there is a concern that the bridging, that is, the bridge member, may be deformed or damaged due to strong centrifugal force.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure provides abridge member capable of preventing deformation or damage of a bridge member assembled to a rotor even when the rotor of a switched reluctance motor rotates at a high speed.

According to the present disclosure, a switched reluctance motor may include a stator 1 provided with a plurality of magnetic pole protrusions 10 having a coil wound thereon; a rotor 3 provided with a plurality of magnetic pole protrusions 5 and made of a magnetic member; a bridge member 4 formed in a substantially T-shaped sectional shape consisting of a roof portion 4a, a leg portion 4b, and a foot portion 4c and burying a gap 9 between the magnetic pole protrusions 5 of the rotor 3 in a state of being supported to the rotor 3 at three places comprising the foot portion 4c and opposite end portions of the roof portion 4a; and end plates 6 configured to close opposite end portions of the rotor 3 in an axial direction, wherein the foot portion 4c of the bridge member 4 is inserted and fitted into a groove 8 of the rotor 3 for fixing a foot of the rotor 3.

The bridge member 4 may be made of a non-magnetic resin. The roof portion 4a may be formed with end portions 4e at opposite end portions thereof, respectively, and the end portions 4e may be engaged with and fitted in end portions 5a of the magnetic pole protrusion 5, respectively. The roof portion 4a may be formed with convex portions 4d at opposite end portions thereof, respectively, and the convex portions 4d may be engaged with and fitted in concave portions 5b of the magnetic pole protrusion 5, respectively.

As described above, according to the switched reluctance motor of the present disclosure, since there is provided a bridge member (4) formed in a substantially T-shaped sectional shape consisting of a roof portion (4a), a leg portion (4b), and a foot portion (4c) and supported to a rotor 3 at three places including the foot portion (4c) and opposite end portions of the roof portion (4a), even when the rotor is rotated at a high speed of 30,000 (number of revolutions/minute), the bridge member maybe prevented from being deformed or damaged due to centrifugal force. Specifically, since the foot portion 4c of the bridge member 4 is inserted and fitted into a groove 8 of the rotor 3 for fixing a foot of the rotor 3, the bridge member is not pushed outward in a radial direction even when centrifugal force is applied thereto and is therefore not damaged. In addition, the bridge member 4 buries the outer circumferential portion of the gap 9 between the magnetic pole projections of the rotor 3, whereby wind damage may also be minimized.

Since the bridge member 4 is made of a non-magnetic resin, there is no leak of magnetic flux. In addition, it is easier to process compared to non-magnetic copper or aluminum. By providing end portions 4e at opposite ends of the roof portion 4a and being engaged with and fitted in the end portions 5a and 5a of the magnetic pole protrusions 5, the bridge member 4 maybe firmly supported on the rotor body even when strong centrifugal force caused by the high speed rotation is applied thereto. By providing convex portions 4d at opposite ends of the roof portion 4a and being engaged with and fitted in concave portions 5b of the magnetic pole protrusions 5, the bridge member 4 maybe firmly supported on the rotor body even when strong centrifugal force caused by the high speed rotation is applied thereto.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing a structure of a stator and a rotor of a switched reluctance motor according to the present disclosure;

FIG. 2 is a view showing the rotor of FIG. 1 (a front view in an axial direction)according to the present disclosure;

FIGS. 3A and 3B are perspective views showing a main body portion and a bridge member of the rotor of FIG. 1 according to the present disclosure;

FIG. 4 is an exploded perspective view of the switched reluctance motor of FIG. 1 according to the present disclosure;

FIG. 5 is a partial perspective view of a portion near a magnetic pole protrusion of the rotor of FIG. 1 according to the present disclosure;

FIG. 6 is a partial perspective view of the bridge member of FIG. 1 according to the present disclosure;

FIG. 7 is a front view of the rotor of FIG. 1 according to the present disclosure;

FIGS. 8A and 8B show examples in which the roof portions of the bridge members are engaged with and fitted in the magnetic pole protrusions according to the present disclosure;

FIGS. 9A to 9C show examples in which foot portions of the bridge members are inserted and fitted into portions of the main body of the rotor according to the present disclosure;

FIG. 10 is an example in which the bridge member is divided according to the present disclosure;

FIG. 11 is a graph showing a relationship between windage loss and a number of revolutions/min according to the present disclosure;

FIGS. 12A and 12B are views showing structures of general synchronous motors (PMSM and SRM) according to the prior art; and

FIG. 13 is an example of a variable magnet resistive motor shown in Patent Document 1 according to the prior art.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, exemplary embodiments of the present disclosure will be described in detail with reference to the accompanying drawings.

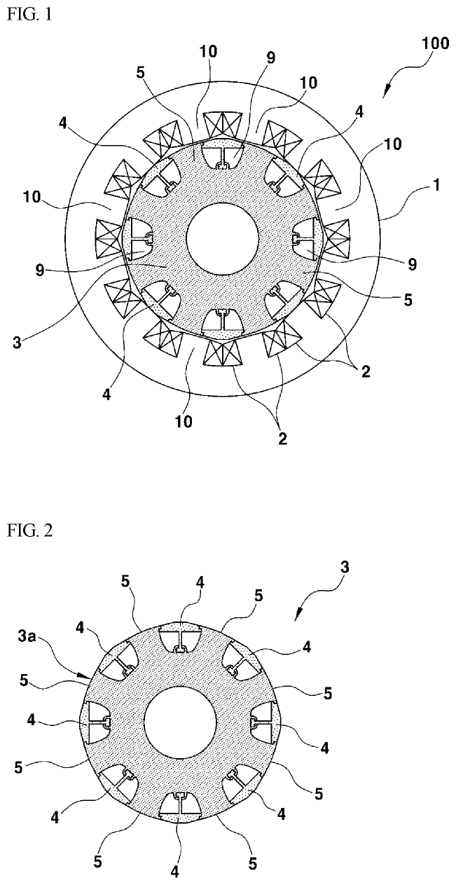

FIG. 1 is a view showing a structure of a stator 1 and a rotor 3 of a switched reluctance motor 100 according to the present disclosure. In the present exemplary embodiment, the stator 1 has 12 magnetic pole protrusions 10, and a coil 2 is wound around each of the magnetic pole protrusions 10. The rotor 3 is attached to a rotating shaft and rotates at the high speed using a property that iron is attracted when the coil 2 of the stator 1 generates a magnetic flux. The rotor 3 is provided with a plurality (e.g., eight in the exemplary embodiment) of magnetic pole protrusions 5 and may be made of a silicon steel plate having a laminated structure. In an inter magnetic pole protrusion gap 9 between the magnetic pole protrusion 5 and the magnetic pole protrusion 5, a bridge member 4 may be installed to bury an outer peripheral portion of the rotor 3. Since the outer peripheral portion of the rotor 3 may be buried with the bridge member 4, windage loss when the rotor 3 rotates at the high speed may be suppressed. In general, the switched reluctance motor does not use an expensive permanent magnet, is capable of rotating at a high speed, and has a structure only winding a coil around the magnetic pole protrusion 10, thereby being suitable for mass production and being capable of realizing low cost.

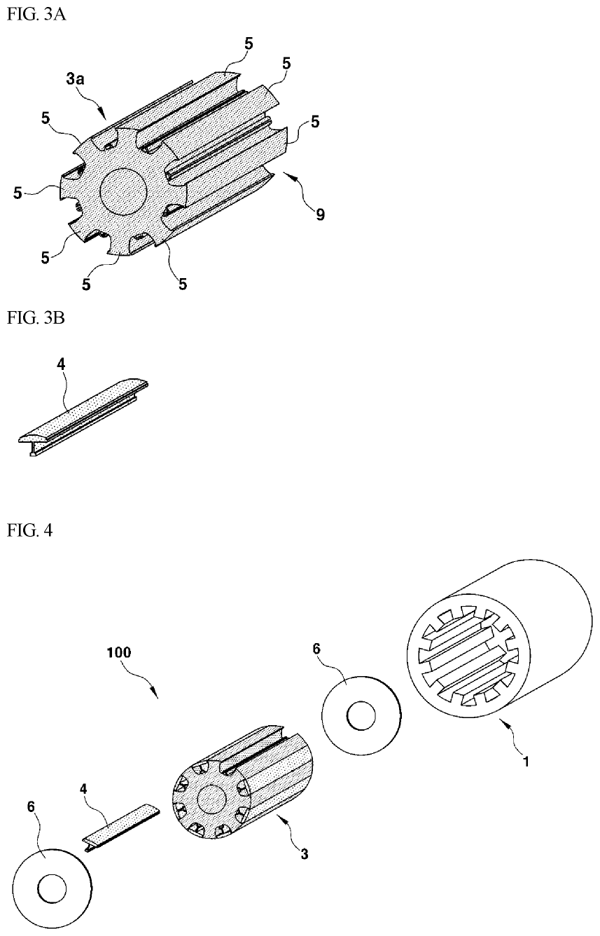

FIG. 2 is a view showing the rotor of FIG. 1 (a front view in an axial direction). In FIGS. 3A and 3B, FIG. 3A is a perspective view showing a main body portion of the rotor 3 of FIG. 1, and FIG. 3B is a perspective view showing a bridge member of FIG. 1. The bridge member 4 may be inserted and fitted into the body portion 3A to be removed from the body portion 3A. The bridge member 4 may be formed of a non-magnetic material and may be made using copper, aluminum, ceramic, or the like. However, the bridge member 4 may be formed of a resin in the present exemplary embodiment. Specifically, a mold may be formed, and then resin may be spilled into the mold to form the bridge member 4.

FIG. 4 is an exploded perspective view of the switched reluctance motor 100 of FIG. 1. End plates 6 are provided to close opposite end portions in the axial direction of the rotor 3. In FIG. 4, the illustration of the rotating shaft is omitted. The switched reluctance motor 100 may include the stator 1, the rotor 3, a plurality of the bridge members 4, and the end plates 6.

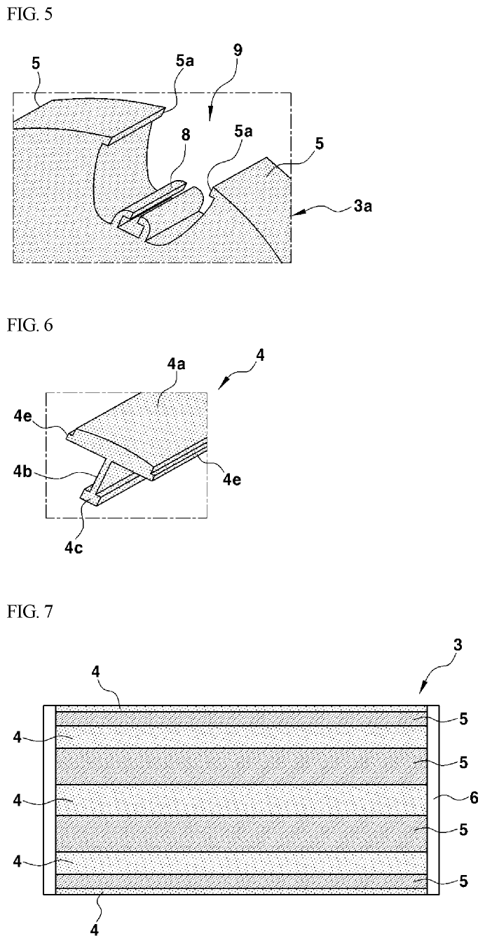

FIG. 5 is a partial perspective view of a portion near a magnetic pole protrusion 5 of the rotor 3 of FIG. 1. Between the magnetic pole protrusion 5 and the magnetic pole protrusion 5, an inter magnetic pole protrusion gap 9 may be formed. In the bottom of the gap 9 of the main body 3a of the rotor 3, a groove 8 for fixing a foot may be formed. The magnetic pole protrusion 5 has end portions 5a formed along the axial directions at opposite end portions thereof, and each of the end portions 5a protrudes to the corresponding inter magnetic pole protrusion gap 9.

FIG. 6 is a partial perspective view of the bridge member 4 of FIG. 1. The bridge member 4 may have a substantially T-shaped sectional shape including a roof portion 4a, a leg portion 4b, and a foot portion 4c. End portions 4e may be provided at opposite end portions of the roof 4a. The end portions 4e of the bridge member 4 may be engaged with and fitted in the end portions 5a of the magnetic pole protrusion 5. The foot portion 4c of the bridge member 4 may be inserted and fitted into the groove 8 for fixing a foot in FIG. 5.

FIG. 7 is a front view of the rotor 3 of FIG. 1. The end plates 6 may be provided at the opposite end portions in the axial direction of the rotor 3, and the opposite end portions may be closed. In a circumferential direction of the rotor 3, the magnetic pole protrusions 5 and the bridge members 4 may be arranged alternately.

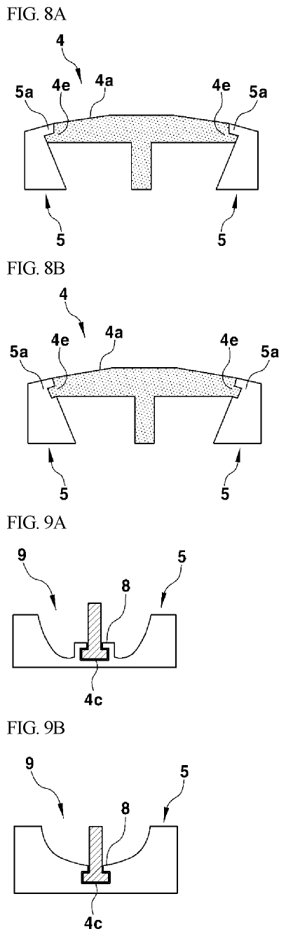

FIGS. 8A and 8B show examples in which the roof portions 4a of the bridge members 4 are engaged with and fitted in the magnetic pole protrusions 5. In FIG. 8A, end portions 4e provided at opposite end portions of the roof portion 4a may be engaged with and fitted in the end portions 5a of the magnetic pole protrusion 5. In FIG. 8B, convex portions 4d provided at opposite end portions of the roof portion 4a may be engaged with and fitted in concave portions 5b of the magnetic pole protrusion 5. According to the examples of FIGS. 8A and 8B, even when a centrifugal force is applied on the bridge member 4, the movement of the bridge member 4 outward in a radial direction may be suppressed.

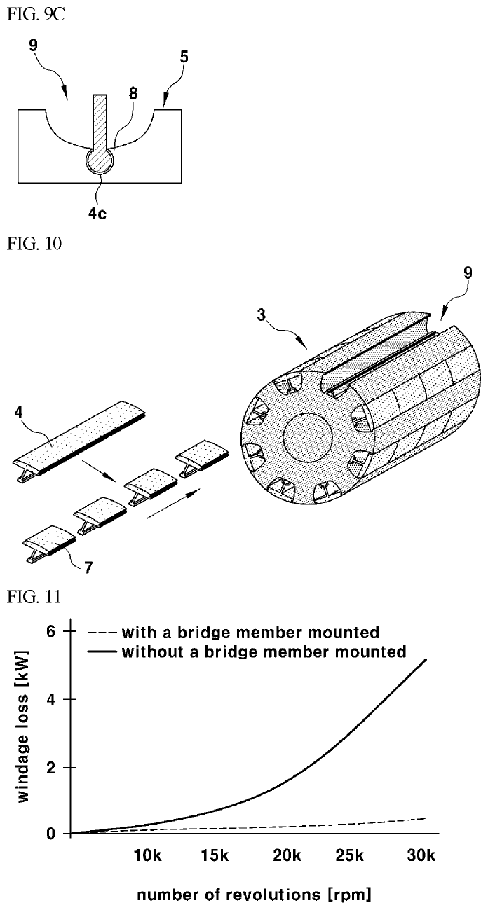

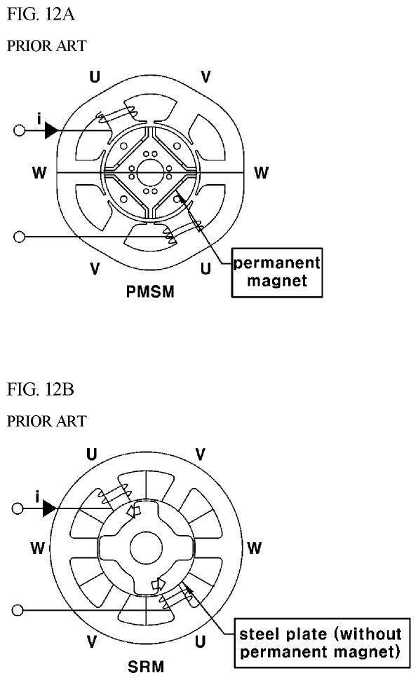

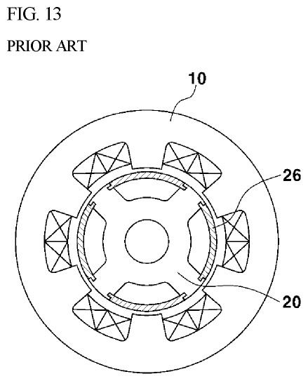

FIGS. 9A to 9C show examples in which the foot portions 4c of the bridge members 4 are inserted and fitted into portions of the main body 3a of the rotor 3. In FIG. 9A, the groove 8 for fixing a foot may be provided in a bulging part of the main body 3a and inserted and fitted with the foot portion 4c of the bridge member 4 thereinto. The foot portion 4c may have a rectangular shape when viewed from a side thereof and a long shape in an axial direction. In FIG. 9B, a groove 8 for fixing a foot portion may be disposed inside the main body 3a without providing a bulging part and may be inserted and fitted with the foot 4c of the bridge member 4 thereinto. In FIG. 9C, a groove 8 for fixing a foot portion may be disposed inside the main body 3a and may be inserted and fitted with a foot portion 4c of the bridge member 4 thereinto. The foot portion 4c may have a circular shape when viewed from a side thereof and a long shape in the axial direction. According to the examples of FIGS. 9A to 9C, even when a centrifugal force is applied on the bridge member 4, the movement of the bridge member 4 outward in a radial direction may be suppressed.

FIG. 10 is an example in which the bridge member 4 is divided. When the rotor 3 is long in the axial direction, the bridge member 4 may be divided into a plurality of segmented pieces 7 and inserted and fitted into the rotor 3.

FIG. 11 is a graph showing a relationship between windage loss and a number of revolutions/min. The windage loss significantly increases when the number of revolutions of the rotor 3 reaches 20,000 to 30,000 (number of revolutions/minute) when the bridge member 4 is not mounted. On the other hand, when the bridge member is mounted, as shown in FIG. 11, the windage loss may be pressed low. Even at such high speed rotation, it may be confirmed that there is no deformation or damage of the bridge member 4.

The present disclosure is the switched reluctance motor provided with the bridge member having no deformation caused by centrifugal force, even when the motor is rotated at the high speed, and suits very well for the industrial application.

Although an exemplary embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A switched reluctance motor, comprising:
a stator having a plurality of magnetic pole protrusions with a coil wound thereon;
a rotor having a plurality of magnetic pole protrusions;
a bridge member formed in a T-shaped sectional shape including a roof portion, a leg portion, and a foot portion and burying a gap between the magnetic pole protrusions of the rotor in a state of being supported to the rotor at three places comprising the foot portion and opposite end portions of the roof portion; and
end plates configured to close opposite end portions of the rotor in an axial direction,
wherein the foot portion of the bridge member is inserted and fitted into a groove of the rotor for fixing a foot of the rotor.

2. The motor of claim 1, wherein the bridge member is made of a non-magnetic resin.

3. The motor of claim 1, wherein the rotor is made of a magnetic member.

4. The motor of claim 3, wherein the roof portion is formed with end portions at opposite end portions thereof, respectively, and the end portions are engaged with and fitted in end portions of the magnetic pole protrusion, respectively.

5. The motor of claim 3, wherein the roof portion is formed with convex portions at opposite end portions thereof, respectively, and the convex portions are engaged with and fitted in concave portions of the magnetic pole protrusion, respectively.

6. A vehicle including a switched reluctance motor, the motor comprising:
a stator having a plurality of magnetic pole protrusions with a coil wound thereon;
a rotor having a plurality of magnetic pole protrusions;
a bridge member formed in a T-shaped sectional shape including a roof portion, a leg portion, and a foot portion and burying a gap between the magnetic pole protrusions of the rotor in a state of being supported to the rotor at three places comprising the foot portion and opposite end portions of the roof portion; and
end plates configured to close opposite end portions of the rotor in an axial direction,
wherein the foot portion of the bridge member is inserted and fitted into a groove of the rotor for fixing a foot of the rotor.
